(19) United States
(12) Patent Application Publication
(10) Pub. No.: US 2020/0395163 A1
(43) Pub. Date: Dec. 17, 2020

(54) ELECTRICAL INDUCTOR DEVICE

(71) Applicant: FORD GLOBAL TECHNOLOGIES, LLC, Dearborn, MI (US)

(72) Inventor: Leyi Zhu, Novi, MI (US)

(21) Appl. No.: 16/443,287

(22) Filed: Jun. 17, 2019

(51) Int. Cl. H01F 27/255; H01F 27/28

(52) U.S. Cl. CPC H01F 27/255; H01F 27/28

(57) ABSTRACT

An inductor that is configured to generate a magnetic field includes a coil disposed about a magnetic core. The core comprises a magnetic powder suspended in a non-magnetic matrix. The magnetic powder comprises spherically-shaped particles, disk-shaped particles, and elongated fibers. The disk-shaped particles have radii that are substantially parallel with the magnetic field. The elongated fibers have lengths that are substantially parallel with the magnetic field.

### TECHNICAL FIELD

The present disclosure relates to electrical inductor devices that include a coil and a magnetic core.

### BACKGROUND

Electrical inductor devices may include an electrical wire (i.e., a coil) that is configured to generate a magnetic field when energized.

### SUMMARY

An inductor that is configured to generate a magnetic field includes a coil disposed about a magnetic core. The core comprises a magnetic powder suspended in a non-magnetic matrix. The magnetic powder has spherically-shaped particles and disk-shaped particles. The disk-shaped particles have radii and thicknesses. The radii of the disk-shaped particles are substantially parallel with the magnetic field and the thicknesses of the disk-shaped particles are substantially perpendcular to the generated magnetic field.

An inductor that is configured to generate a magnetic field includes a coil disposed about a magnetic core. The core comprises a magnetic powder suspended in a non-magnetic matrix. The magnetic powder has spherically-shaped particles and elongated fibers. The elongated fibers have lengths and circular cross-sections. The lengths of the fibers are substantially parallel with the magnetic field and the cross-sections of the fibers are substantially perpendicular to the generated magnetic field.

An inductor that is configured to generate a magnetic field includes a coil disposed about a magnetic core. The core comprises a magnetic powder suspended in a non-magnetic matrix. The magnetic powder comprises spherically-shaped particles, disk-shaped particles, and elongated fibers. The disk-shaped particles have radii that are substantially parallel with the magnetic field. The elongated fibers have lengths that are substantially parallel with the generated magnetic field.

### BRIEF DESCRIPTION OF THE DRAWINGS

FIG. 1 illustrates an exemplary electrical inductor;

FIG. 2 is a cross-sectional view of the electrical inductor taken along line 2-2 in FIG. 1;

FIG. 3 is a graph illustrating the relative magnetic permeabilities of inductor cores that are made from magnetic powders and non-magnetic matrixes based on the shapes of the particles of the magnetic powders and the volumes of the non-magnetic matrixes relative to the total volumes the inductor cores;

FIG. 4 is a grayscale microscopic image of a magnetic powder having disk-shaped particles;

FIG. 5A is a grayscale microscopic image of a magnetic powder having elongated fibers that form the particles of the magnetic powder;

FIG. 58 is a magnified view of the area 5B in FIG. 5A;

FIG. 6 illustrates a first embodiment of an inductor core that is made from a magnetic powder and a non-magnetic matrix, where the magnetic powder is comprised of spherically-shape particles and disk-shaped particles;

FIG. 7 illustrates a second embodiment of an inductor core that is made from a magnetic powder and a non-magnetic matrix, where the magnetic powder is comprised of spherically-shape particles and elongated fibers; and

FIG. 8 illustrates a third embodiment of an inductor core that is made from a magnetic powder and a non-magnetic matrix, where the magnetic powder is comprised of spherically-Shape particles, disk-shaped particles, and elongated fibers.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

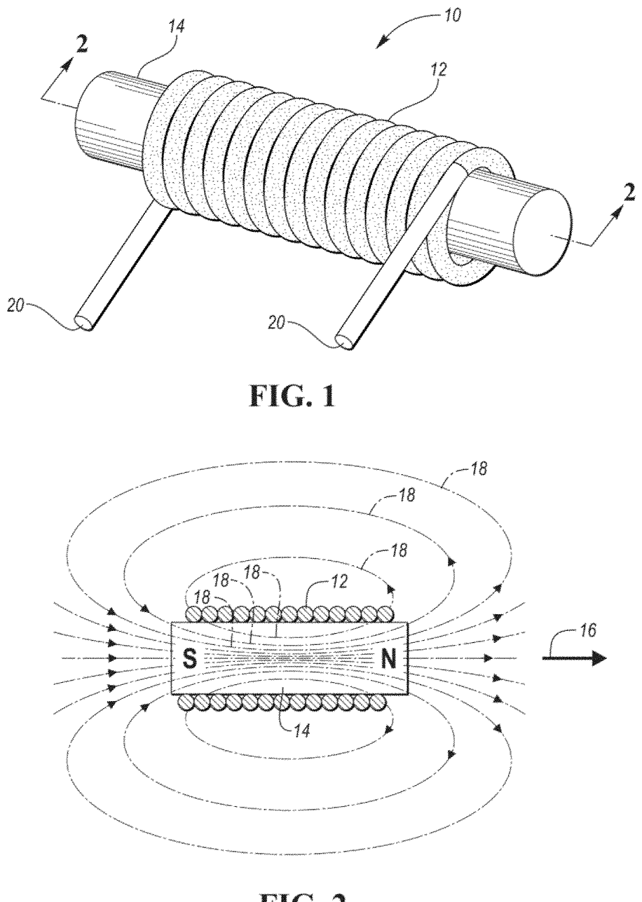

Referring to FIGS. 1 and 2 an electrical inductor 10 is illustrated. The electrical inductor 10 includes a coil 12 that is disposed about (e.g., is wrapped around) an inductor core 14, which may be a magnetic inductor core. The inductor core 14 may be made from a material that has the properties of a soft magnet. The inductor core 14 has a magnetic moment 16 that represents the magnetic strength and orientation of the magnet that comprises the inductor core 14. More specifically, the magnetic moment 16 represents the magnetic dipole moment that extends from the South pole to the North pole of a Magnet. The magnetic moment 16 may be defined in terms of torque that an object experiences in a magnetic field that is generated by the permanent magnet that comprises the inductor core 14. When an electrical power source, such as a battery or a generator, is connected to terminals 20 of the coil 12 and delivers electricity to the coil 12, the coil 12 is energized and generates a magnetic field. The magnetic field generated by the coil 12 is represented by lines 18 in FIG. 2. The magnetic inductor core 14 may amplify the magnetic field generated by the coil 12. It should be understood that the electrical inductor 10 of FIGS. 1 and 2 is for illustrative purposes only and that the electrical inductor 10 may have an alternative shape. For example, the electrical inductor 10 may be a torpid-shaped inductor, C-shaped inductor that includes an air gap, or may be a design where the coil is surrounded by the core.

An inductor is an electrical device that includes a wire wound into a coil (e.g., coil 12) around a core (e.g., inductor core 14). An inductor stores energy in a magnetic field when electric current flows through the coil. Depending on the materials used in the core, the inductor can be classified as an “air core” design, a “laminated core” design, and/or a “powder core” design. In a powder core inductor design, the core may be constructed from ferromagnetic powders that are surrounded by an electrical insulating non-magnetic matrix, which may be a binder material or polymer-based material such as epoxy. A powder core inductor is a distributed air gap core that may possess desired properties, such as high resistivity, low eddy current loss, and good inductance stability. However, the permeability of powder core inductor designs decreases as the percentage of the non-magnetic matrix material that comprises the core of the inductor increases.

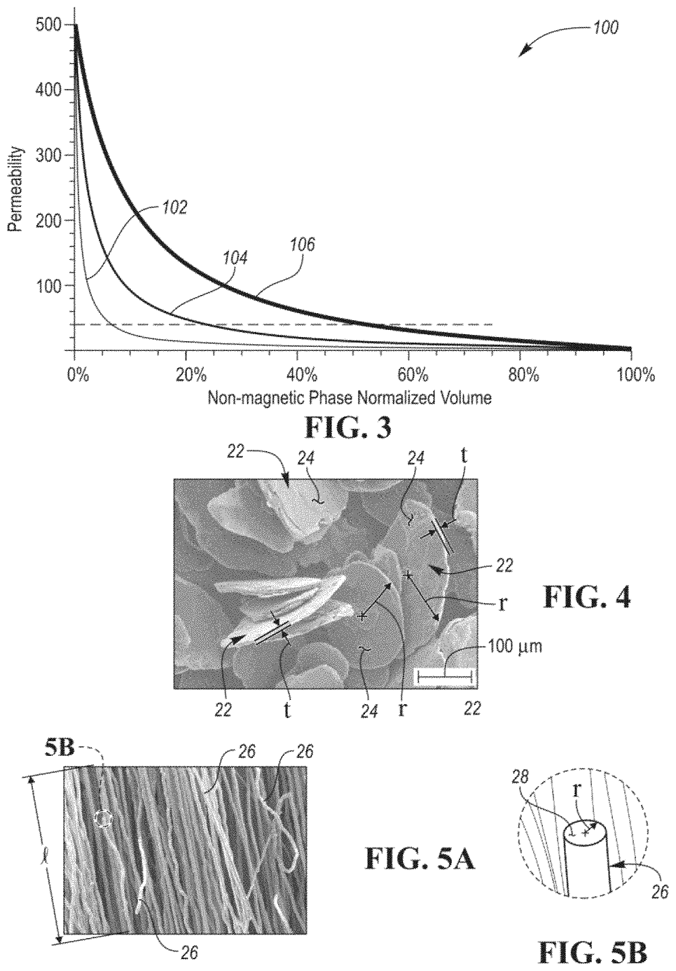

Referring to FIG. 3 a graph 100 illustrating the relative magnetic permeabilities of inductor cores that are made from magnetic powders and non-magnetic matrixes based on the shapes of particles of the magnetic powders and the volumes of the non-magnetic matrixes of the inductor cores relative to the total volumes of the inductor cores. The magnetic permeabilities illustrated in FIG. 3 are more specifically relative to vacuum permeability. FIG. 3 illustrates that the magnetic permeability of an inductor core that is made from magnetic powders decreases as the volume of the non-magnetic matrix material in the inductor core increases relative to the total volume of the inductor core.

Line 102 represents the magnetic permeability of an inductor core relative to the volume of the non-magnetic matrix of an inductor core that is made from a magnetic powder having spherically-shaped particles. In order to maintain a relative permeability of a least 40, which is required in some applications for the inductor to be useful, the amount of the non-magnetic matrix material comprising an inductor core having spherically-shaped particles needs to be reduced to less than 7% of the total volume of the inductor core. This may be achieved by loading the magnetic powder by utilizing compaction molding where a large pressure is applied to the magnetic powder and non-magnetic matrix material during the manufacture of the inductor core in order to increase the volume of the magnetic powder and decrease the volume of the non-magnetic matrix material. For other inductor core manufacturing methods, such as injection molding, transfer molding, and 3D printing, it may be difficult to apply a large enough load on the magnetic powder to increase the volume of the magnetic powder and decrease the volume of the non-magnetic matrix material.

The shape attic particles of the magnetic powder affects the permeability of the core due to the demagnetization effect. Magnetic powders having disk-shaped or flake-shaped particles may be utilized to increase the permeability of an inductor core relative to the volume of the inductor core that is comprised of the non-magnetic matrix material. Line 104 represents the magnetic permeability of an inductor core relative to the volume of the non-magnetic matrix material of an inductor core that is made from a magnetic powder having disk-shaped particles. Referring to FIG. 4, a grayscale microscopic image of a magnetic powder having disk-shaped particles 22 is illustrated. The disk-shaped particles 22 may each have a radius, r, and a thickness, t. In a preferred embodiment, a ratio of the radius, r, to the thickness, t, of each disk-shaped particle 22 may be a least 2 to 1. In another preferred embodiment, the ratio of the radius, r, to the thickness, t, of each disk-shaped particle 22 may be a least 10 to 1.

When an inductor core is made front a magnetic powder having disk-shaped particles 22, and when the broad surfaces (or flake-planes) 24 and radii, r, of the disk-shaped particles 22 are aligned with an external magnetic field, H, that is produced by the inductor when energized, the core permeability decays slower as a function of the volume of the non-magnetic matrix material relative to the inductor core that is made from the magnetic powder having spherically-shaped particles. The permeability of an inductor core depends on the alignment between broad surfaces 24 of the disk-shaped particles and the external magnetic field generated by the inductor. The alignment of the broad surfaces 24 of the disk shape particles 22 may be achieved by applying a magnetic field to the inductor core during the manufacturing or molding process utilized to construct the inductor core. During manufacturing, the magnetic field is applied along the same direction as the external magnetic field that will be produced by the inductor when energized such that the broad surfaces 24 of the disk-shaped particles 22 are aligned with an external magnetic field when subsequently produced by the inductor. More specifically, the broad surfaces 24 and radii, r, of the disk-shaped particles 22 may be substantially parallel to the external magnetic field, H, that is produced by the inductor when energized and the thicknesses, t, of the disk-shaped particles 22 may be substantially perpendicular to the external magnetic field, H, that is produced by the inductor when energized. Substantially parallel may refer to any incremental value the ranges from exactly parallel to 30° from exactly parallel. Substantially perpendicular may refer to any incremental value the ranges from exactly perpendicular to 30° from exactly perpendicular.

As illustrated in FIG. 3, in order to achieve a core relative permeability of 40 or above, the volume of the non-magnetic matrix material of an inductor core having disk-shaped particles 22 may be increased to 26% of the total volume of the inductor core while the volume of the non-magnetic matrix material in the inductor core that is made from spherically-shaped magnetic particles may only be increased to 7% of the total volume of the inductor core. Some inductor designs, however, may not require a core that has a core relative permeability of 40 or above. For, example sonic designs may only require a core relative permeability of approximately 10 or above, which would further allow the volume of the non-magnetic matrix material of an inductor core having disk shaped particles 22 to be increased to 70% of the total volume of the inductor core. It should be understood that any remaining volume of an inductor that is not occupied by the non-magnetic matrix material will be occupied by the magnetic powder.

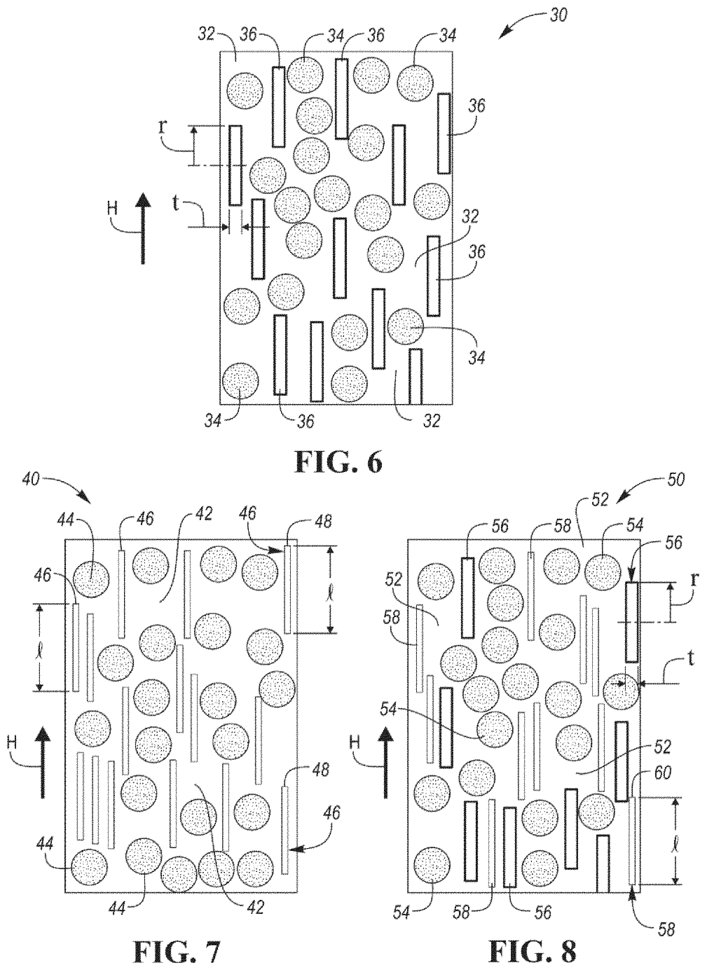

Magnetic powders having elongated fibers that have circular cross-sections may be utilized to increase the permeability of an inductor core relative to the volume of the inductor core that is comprised of the non-magnetic matrix material. Line 106 in FIG. 3 represents the magnetic permeability of an inductor core relative to the volume of the non-magnetic matrix material of an inductor core that is made from a magnetic powder having elongated fibers. Referring to FIGS. 5A and 5B, a grayscale microscopic image of a magnetic powder having elongated fibers 26 is illustrated. The elongated fibers 26 may each have a length l, and a circular cross-section 28. The circular cross-section 28 of each elongated fiber 26 may have a radius, r. In a preferred embodiment, a ratio of the length, l, to the radius, r, of each elongated fiber 26 may be a least 2 to 1. In another preferred embodiment, the ratio of the length, l, to the radius, r, of each elongated fiber 26 may be a least 10 to 1.

When an inductor core is made from a magnetic powder having elongated fibers 26, and the long axis or length, l, of the elongated fibers 26 are aligned with an external magnetic field, H, that is produced by the inductor when energized, the core permeability decays slower as a function of the volume of the non-magnetic matrix material relative to the inductor core that is made from the magnetic powder having spherically-shaped particles and the inductor core that is made from the magnetic powder having disk-shaped particles. The permeability of an inductor core depends on the alignment between the lengths, l, of the elongated fibers 26 and the external magnetic field generated by the inductor. The alignment of the lengths, l, of the elongated fibers 26 may be achieved by applying a magnetic field during the manufacturing or molding process utilized to construct the inductor core. During manufacturing, the magnetic field is applied along the same direction as the external magnetic field that will be produced by the inductor when energized such that the lengths, l, of the elongated fibers 26 are aligned with the external magnetic field when subsequently produced by the inductor. More specifically, the lengths, l, of the elongated fibers 26 may be substantially parallel to the external magnetic field, H, that is produced by the inductor when energized and the circular cross-sections 28 (or more specifically the surfaces that represent the circular cross-sections 28) of the elongated fibers 26 may be substantially perpendicular to the external magnetic field, H, that is produced by the inductor when energized. Substantially parallel may refer to any incremental value the ranges from exactly parallel to 30° from exactly parallel. Substantially perpendicular may refer to any incremental value the ranges from exactly perpendicular to 30° from exactly perpendicular.

As illustrated in FIG. 3, in order to achieve a core relative permeability of 40 or above, the volume of the non-magnetic matrix material of an inductor core having elongated fibers 26 may be increased to 58% of the total volume of the inductor core while the volume of the non-magnetic matrix material in the inductor core that is made from spherically-shaped magnetic particles may only be increased to 7% of the total volume of the inductor core. Some inductor designs, however, may not require a core that has a core relative permeability of 40 or above. For example some designs may only require a core relative permeability of approximately 10 or above, which would further allow the volume of the non-magnetic matrix material of an inductor core having elongated fibers 26 to be increased to 90% of the total volume of the inductor core. It should be understood that any remaining volume of an inductor that is not occupied by the non-magnetic matrix material will be occupied by the magnetic powder.

Compared with cores made of magnetic sphere powders, cores made with flakes and fibers may have increased eddy current loss due to the larger dimensions of the powders in the external magnetic field that is generated by the coil of the inductor. To balance core loss and core permeability, a magnetic powered haying spherical shaped particles and disk-shaped particles and/or elongated fibers may be utilized to construct the inductor core. Several magnetic powder designs are proposed for inductor cores that achieve a useful permeability while also not limiting the non-magnetic phase to a small percentage of the overall volume of the inductor core.

Referring to FIG. 6, a first embodiment of an inductor core 30 that is made from a magnetic powder and a non-magnetic matrix material 32 is illustrated. It should be understood that the inductor core 30 is a subcomponent of an inductor that includes the inductor core 30 and a coil (e.g., FIGS. 1 and 2). The coil is not included in FIG. 6 for illustrative purposes. The magnetic powder is comprised of spherically-shape particles 34 and disk-shaped particles 36. The disk-shaped particles 36 have the same properties as the disk-shaped particles 22 described with respect to FIG. 4. Broad surfaces and radii, r, of the disk-shaped particles 36 may be substantially parallel to the external magnetic field, H, that is produced by the inductor when energized. Thicknesses, t, of the disk-shaped particles 36 may be substantially perpendicular to the external magnetic field, H, that is produced by the inductor when energized. The non-magnetic matrix material 32 may comprise a volume of the magnetic core 30 that ranges between 5% and 70% of the total volume of the magnetic core, while the magnetic powder may comprise a volume of the magnetic core that ranges between 30% and 95% of the total volume of the magnetic core 30.

Referring to FIG. 7, a second embodiment of an inductor core 40 that is made from a magnetic powder and a non-magnetic matrix material 42 is illustrated. It should be understood that the inductor core 40 is a subcomponent of an inductor that includes the inductor core 40 and a coil (e.g.. FIGS. 1 and 2). The coil is not included in FIG. 7 for illustrative purposes. The magnetic powder is comprised of spherically-shape particles 44 and elongated fibers 46. The elongated fibers 46 have the same properties as the elongated fibers 26 described with respect to FIG. 5A. Lengths, l, of the elongated fibers 46 may be substantially parallel to the external magnetic field, H, that is produced by the inductor when energized. Circular cross-sections 48 (or more specifically the surfaces that represent the circular cross-sections 48) of the elongated fibers 46 may be substantially perpendicular to the external magnetic field, H, that is produced by the inductor when energized. The non-magnetic matrix material 42 may comprise a volume of the magnetic core 40 that ranges between 5% and 70% of the total volume of the magnetic core, while the magnetic powder may comprise a volume of the magnetic core that ranges between 30% and 95% of the total volume of the magnetic core 40.

Referring to FIG. 8, a third embodiment of an inductor core 50 that is made from a magnetic powder and a non-magnetic matrix material 52 is illustrated. It should be understood that the inductor core 50 is a subcomponent of an inductor that includes the inductor core 50 and a coil (e.g., FIGS. 1 and 2). The coil is not included in FIG. 8 for illustrative purposes. The magnetic powder is comprised of spherically-shape particles 54, disk-shaped particles 56, and elongated fibers 58. The disk-shaped particles 56 have the same properties as the disk-shaped particles 22 described with respect to FIG. 4. Broad surfaces and radii, r, of the disk-shaped particles 56 may be substantially parallel to the external magnetic field, H, that is produced by the inductor when energized. Thicknesses, t, of the disk-shaped particles 56 may be substantially perpendicular to the external magnetic field, H, that is produced by the inductor when energized. The elongated fibers 58 have the same properties as the elongated fibers 26 described with respect to FIG. 5A. Lengths, l, of the elongated fibers 58 may be substantially parallel to the external magnetic field, H, that is produced by the inductor when energized. Circular cross-sections 60 (or more specifically the surfaces that represent the circular cross-sections 60) of the elongated fibers 58 may be substantially perpendicular to the external magnetic field, H, that is produced by the inductor when energized. The non-magnetic matrix material 52 may comprise a volume of the magnetic core 50 that ranges between 5% and 70% of the total volume of the magnetic core, while the magnetic powder may comprise a volume of the magnetic core that ranges between 30% and 95% of the total volume of the magnetic core 50.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary Skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. An inductor configured to generate a magnetic field comprising:
a coil disposed about a magnetic core, the core comprising a magnetic powder suspended in a non-magnetic matrix, the magnetic powder having spherically-shaped particles and disk-shaped particles, the disk-shaped particles having radii and thicknesses, wherein the radii of the disk-shaped particles are substantially parallel with the magnetic field and the thicknesses of the disk-shaped particles are substantially perpendicular to the generated magnetic field.

2. The inductor of claim 1, wherein the non-magnetic matrix comprises a volume of the magnetic core that ranges between 5% and 70% of a total volume of the magnetic core.

3. The inductor of claim 1, wherein the magnetic powder comprises a volume of the magnetic core that ranges between 30% and 95% of a total volume of the magnetic core.

4. The inductor of claim 1, wherein a ratio of the radii to the thicknesses of the disk-shaped particles is at least 2:1.

5. The inductor of claim 1, wherein magnetic powder further includes elongated fibers having lengths that are substantially parallel with the magnetic field.

6. The inductor of claim 5, wherein the elongated fibers have circular cross-sections that are substantially perpendicular to the magnetic field.

7. The inductor of claim 6, wherein a ratio of the lengths of the fibers to radii of the circular cross-sections of the fibers is at least 2:1.

8. An inductor configured to generate a magnetic field comprising:
a coil disposed about a magnetic core, the core comprising a magnetic powder suspended in a non-magnetic matrix, the magnetic powder having spherically-shaped particles and elongated fibers, the elongated fibers having lengths and circular cross-sections, wherein the lengths of the fibers are substantially parallel with the magnetic field and the cross-sections of the fibers are substantially perpendicular to the generated magnetic field.

9. The inductor of claim 8, wherein the non-magnetic matrix comprises a volume of the magnetic core that ranges between 5% and 70% of a total volume of the magnetic core.

10. The inductor of claim 8, wherein the magnetic powder comprises a volume of the magnetic core that ranges between 30% and 95% of a total volume of the magnetic core.

11. The inductor of claim 8, wherein a ratio of the lengths of the fibers to radii of the circular cross-sections of the fibers is at least 2:1.

12. The inductor of claim 8, wherein magnetic powder further includes disk-shaped particles having radii and thicknesses, wherein the radii of the disk-shaped particles are substantially parallel with the magnetic field.

13. The inductor of claim 12, wherein the thicknesses of the disk-shaped particles are substantially perpendicular to the magnetic field.

14. The inductor of claim 12, wherein a ratio of the radii to the thicknesses of the disk-shaped particles is at least 2:1.

15. An inductor configured to generate a magnetic field comprising:
a coil disposed about a magnetic core, the core comprising a magnetic powder suspended in a non-magnetic matrix, the magnetic powder comprising,
spherically-shaped particles,
disk-shaped particles having radii that are substantially parallel with the generated magnetic field, and
elongated fibers having lengths that are substantially parallel with the generated magnetic field.

16. The inductor of claim 15, wherein the non-magnetic matrix comprises a volume of the magnetic core that ranges between 5% and 70% of a total volume of the magnetic core.

17. The inductor of claim 15, wherein the disk-shaped particles have thicknesses that are substantially perpendicular to the magnetic field.

18. The inductor of claim 17, wherein a ratio of the radii to the thicknesses of the disk-shaped particles is at least 2:1.

19. The inductor of claim 15, wherein the elongated fibers have circular cross-sections that are substantially perpendicular to the magnetic field.

20. The inductor of claim 15, wherein a ratio of the lengths of the fibers to radii of the circular cross-sections of the fibers is at least 2:1.
